(19) United States
(12) Patent Application Publication
(10) Pub. No.: US 2007/0091292 A1
(43) Pub. Date: Apr. 26, 2007

(54) System, medium, and method controlling operation according to instructional movement

(75) Inventors: Sung-jung Cho, Suwon-si (KR); Eun-kwang Ki, Seodaemun-gu (KR); Dong-yoon Kim, Seodaemun-gu (KR); Won-chul Bang, Seongnam-si (KR); Eun-seok Choi, Anyang-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/492,905

(22) Filed: Jul. 26, 2006

(30) Foreign Application Priority Data
Sep. 15, 2005 (KR) 10-2005-0086334

(51) Int. Cl. H02N 3/00

(52) U.S. Cl. 355/75; 310/10; 310/12

(57) ABSTRACT

A system, medium, and method for controlling an operation according to movement. A movement model can be generated based on at least one movement and stored corresponding to a predetermined operation. Movement input by a user may then be compared with the stored movement model, and the predetermined operation can be controlled according to the comparison result. The system may include an inertial sensor sensing movement, a movement probability distribution maker making a probability distribution of movement using stored movement models, a movement comparator determining similarity between a movement model and a movement sensed by the inertial sensor using the probability distribution, and an output unit outputting a operation control signal stored corresponding to a movement model according to a determination result made by the movement comparator.

### CROSS-REFERENCE TO RELATED APPLICATIONS

This application claims priority benefit from Korean Patent Application No. 10-2005-0086334, filed on Sep. 15, 2005, in the Korean Intellectual Property Office, the disclosure of which is incorporated herein by reference in its entirety.

### BACKGROUND OF THE INVENTION

1. Field of the Invention

Embodiments of the present invention relate at least to a system, medium, and method for controlling an operation according to an instructional movement, and more particularly, to a system, medium, and method for controlling an operation according to an instructional movement, in which at least one movement model has been generated based on at least one instructional movement being stored for at least one operation, such that a movement input by a user is compared with the at least one stored movement model, and the corresponding operation is performed according to a comparison result.

2. Description of the Related Art

In movement detection, an inertial sensor typically detects inertial force of a mass generated due to acceleration or angular velocity, which is expressed in a deformation of an elastic structure, and represents the deformation of the elastic structure in an electrical signal using appropriate sensing and signal processing schemes.

Since the 1990's, the development of MicroElectroMechanical Systems (MEMS) using semiconductor processes has allowed for the miniaturization and mass production of inertial sensors. Inertial sensors are largely divided into acceleration sensors and angular velocity sensors and are used in various applications including the position and posture control of a ubiquitous robotic companion (URC), for example. In particular, inertial sensors have been highlighted in applications such as integrated control on a vehicle suspension and brake, an air bag, and a car navigation system. In addition, inertial sensors may similarly be used as data input devices for portable information equipment such as portable navigation systems applied to mobile communication terminals, wearable computers, and personal digital assistants (PDAs). Recently, inertial sensors have further been applied to mobile phones for the recognition of sequential motions in three dimensional games and relevant products, for example. In the field of aerospace, inertial sensors may also be used for a navigation system of both of a normal air vehicle and a macro air vehicle, a missile attitude control system, a personal navigation system for military use, and so on.

As described above, an inertial sensor may be used as, or with, an input device of a mobile terminal. In this case, an inertial sensor may be installed in the mobile terminal, separate from the mobile terminal, or in an input device including the inertial sensor may be connected to the mobile terminal.

Here, when data generated by the inertial sensor is set corresponding to a particular operation, e.g., a particular program or service, of the mobile terminal, a user can use the movement of the inertial sensor to control that operation. For example, the user can play a particular sound effect by reciprocating the mobile terminal and display a particular figure by moving the mobile terminal in the shape of the particular figure.

Korea Patent Publication No. 10-2004-0051202 discusses a registering of a particular movement corresponding to a particular operation of a mobile terminal, such as mode conversion or menu shift, and controlling the operation according to the particular movement of the mobile terminal. In this discussion, when a user selects a particular operation of the mobile terminal and applies a particular movement to the mobile terminal, the particular movement is converted into a terrestrial magnetism signal and an acceleration signal and these signals are stored in a memory unit corresponding to the particular operation. Thereafter, when the user applies the particular movement to the mobile terminal, the mobile terminal controls the particular operation. However, the converted signals are stored as movement setting data, which does not consider the similarity between movement input during registration and movement input during control of a corresponding operation. Accordingly, in this conventional technique, when two similar movements are registered for different operations of the mobile terminal, the mobile terminal may confuse the two movements, thus operating erroneously. In addition, when input time or a user's posture for registration is different from the actual input of movement during operation control, detection sensitivity may degrade.

Accordingly, the inventors of the present application have found that there is a need for recognizing registered movements similar to an instructional movement input corresponding to a particular operation, e.g., in a portable terminal. To avoid a sharp reduction in the detection sensitivity, it has also been found desirable to develop a movement model capable of compensating for temporal or postural differences for movement registration and operation control.

### SUMMARY OF THE INVENTION

Embodiments of the present invention provide at least a system, medium, and method for controlling an operation according to an instructional movement, where a movement model has been generated, and based on at least one movement model being stored corresponding to a predetermined operation, movement input by a user is compared with the stored movement model, and the predetermined operation is controlled according to a comparison result.

Additional aspects and/or advantages of the invention will be set forth in part in the description which follows and, in part, will be apparent from the description, or may be learned by practice of the invention.

To achieve the above and/or other aspects and advantages, embodiments of the present invention include a system for controlling an operation according to movement, including a movement probability distribution maker to make a probability distribution of a sensed movement using a plurality of stored movement models, a movement comparator to determine similarity between movement models, of the plurality of stored movement models, and the sensed movement by a movement sensor using the probability distribution, and a controller to control an operation corresponding to a movement model, of the movement models, according to the determined similarity.

The system may further include an output unit to output an operation control signal for controlling the operation. Here, the operation control signal may include a signal for operating at least one among operations inherently provided in an apparatus and an operation definable by a user.

The system may include an inertial sensor to obtain the sensed movement. In addition, the initial sensor, the movement probability distribution maker, the movement comparator, and the controller may be embodied in a single apparatus body. Further, the inertial sensor may include at least one of an acceleration sensor and an angular velocity sensor.

At least one movement model may include at least one among a number of segments defined by predetermined points in a respective input movement sample to generate the at least one movement model, a correlation between a plurality of movement samples, and a linear relationship matrix including linear variable coefficients determined through learning to reduce a difference between movement samples.

A method of expressing the correlation between the plurality of movement samples may include a covariance matrix. In addition, the correlation may include a variance of the plurality of movement samples at a border corresponding to a predetermined point and an overall variance, of the plurality of movement samples, which has been pre-generated through application of a predetermined weight.

The system may further include a movement model generator to generate the at least one movement model using a movement sample. Here, the movement model generator may include a movement sample receiver to receive the movement sample, a segment creator to divide the received movement sample into segments using the predetermined points as borders, a correlation extractor to extract the correlation between the plurality of movement samples, and a linear relationship extractor to extract the linear relationship matrix including the linear variable coefficients. In addition, the movement model generator may generate the at least one movement model using one among a one-dimensional movement sample, a two-dimensional movement sample, and a three-dimensional movement sample.

The segments may also be defined by using, as borders, points where a direction of movement changes on each of axes in space included in the at least one movement sample.

The movement comparator may determine the similarity between the movement models and the sensed movement using a probability value obtained by applying a magnitude of inertial force of the sensed movement to the probability distribution.

The system may further include a storage unit storing at least one of the movement models and an operation control signal, corresponding to a respective movement model, used by the controller for controlling the operation.

In addition, the system may include a button signal receiver to receive a button input signal for selectively controlling the system to generate a movement model and a button signal controlling the system to review the sensed movement and output a corresponding operation control signal corresponding to a respective movement model, used by the controller for controlling the operation.

To achieve the above and/or other aspects and advantages, embodiments of the present invention include a method of controlling an operation according to movement, the method including making a probability distribution of a sensed movement using a plurality of movement models, determining similarity between movement models, of the plurality of movement models, and the sensed movement using the probability distribution, and controlling an operation corresponding to a movement model, of the movement models, according to the determined similarity.

The method may further include sensing the sensed movement.

In addition, the method may include outputting an operation control signal for the controlling of the operation. The operation control signal may include a signal for operating at least one among operations inherently provided in an apparatus and operations definable by a user.

In addition, the method may include obtaining the sensed movement through a movement sensing device. Here, the obtaining of the sensed movement may include sensing at least one of an acceleration and an angular velocity of the movement.

In addition, the at least one movement model may include at least one among a number of segments defined by predetermined points in a respective input movement sample to generate the at least one movement model, a correlation between a plurality of movement samples, and a linear relationship matrix including linear variable coefficients determined through learning to reduce a difference between movement samples.

The expressing the correlation between the plurality of movement sample may include a covariance matrix. Further, the correlation may include a variance of the plurality of movement samples at a border corresponding to a predetermined point and an overall variance, of the plurality of movement samples, which has been pre-generated through application of a predetermined weight. The method may still further include generating the at least one movement model using a movement sample.

The generating of the at least one movement model may include receiving a movement sample, dividing the received movement sample into segments using the predetermined points as borders, extracting the correlation between the plurality of movement samples, and extracting the linear relationship matrix including the linear variable coefficients.

The generating of the at least one movement model may include generating the at least one movement model using one among a one-dimensional movement sample, a two-dimensional movement sample, and a three-dimensional movement sample.

In addition, the segments may be defined by using, as borders, points where a direction of movement changes on each of axes in space included in the at least one movement sample. Further, the comparing of the sensed movement to determine the similarity between the movement models and the sensed movement may include obtaining a probability value by applying a magnitude of inertial force of the sensed movement to the probability distribution.

The method may still further include storing at least one of the movement models and an operation controlling signal, the operation controlling signal corresponding to a respective movement model and used for controlling the operation.

Further, the method may include selectively controlling a generation of a movement model and reviewing of the sensed movement to output a corresponding operation control signal, corresponding to a respective movement model used by the controller for controlling the operation, based upon an input button signal.

To achieve the above and/or other aspects and advantages, embodiments of the present invention include a method of controlling an operation according to movement, the method including receiving a selection command selecting at least one operation among supported operations, receiving movement after receipt of the selection command, comparing the received movement with stored movements to determine corresponding similarities, and storing the received movement as being for the one operation based on a similarity result of the comparison of the received movement with the stored movements.

The method may include displaying a list of supported operations. In addition, the receiving of the selection command may include receiving the selection command selecting at least one of operations included in the list and a currently controlled operation.

The storing of the received movement may include restoring a trajectory of the received movement and converting the trajectory into coordinates, generating a figure based on the coordinates, and displaying the figure and a title of an operation corresponding to the selection command.

The coordinates may include at least one among one-dimensional coordinates, two-dimensional coordinates, and three-dimensional coordinates.

To achieve the above and/or other aspects and advantages, embodiments of the present invention include a method of controlling an operation according to movement, the method including receiving movement, comparing the received movement with stored movements to determine corresponding similarities, receiving a selection command selecting at least one operation among supported operations, to correspond with the received movement, and storing the received movement as corresponding to the one operation based on a similarity result of the comparison of the received movement with the stored movements.

The method may further include displaying a list of supported operations. In addition, the receiving of the selection command includes receiving the selection command selecting at least one of operations included in the list and a currently controlled operation.

The storing of the received movement may include restoring a trajectory of the received movement and converting the trajectory into coordinates, generating a figure based on the coordinates, and displaying the figure and a title of an operation corresponding to the selection command.

The coordinates may include at least one among one-dimensional coordinates, two-dimensional coordinates, and three-dimensional coordinates.

To achieve the above and/or other aspects and advantages, embodiments of the present invention include at least one medium including computer readable code to implement embodiments of the present invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A illustrates an apparatus/system for controlling an operation according to an instructional movement, according to an embodiment of the present invention;

FIG. 1B illustrates a movement model generator, such as that illustrated in FIG. 1, according to an embodiment of the present invention;

FIG. 2 illustrates movement samples, according to an embodiment of the present invention;

FIG. 3 illustrates cases where a midpoint is determinable based on endpoints of a segment, according to an embodiment of the present invention;

FIG. 4 illustrates a relationship between endpoints of different segments, according to an embodiment of the present invention;

FIG. 5 illustrates a correspondence of segments between movement samples, according to an embodiment of the present invention;

FIG. 6 illustrates particular borders corresponding to each other, between a plurality of movement samples, according to an embodiment of the present invention;

FIG. 7 illustrates a registering movement process, according to an embodiment of the present invention;

FIG. 8 illustrates a process of controlling an operation, according to movement according to an embodiment of the present invention;

FIG. 9 illustrates an example in which a figure of a registered movement is displayed, according to an embodiment of the present invention; and

FIG. 10 illustrates a trajectory restoration unit, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

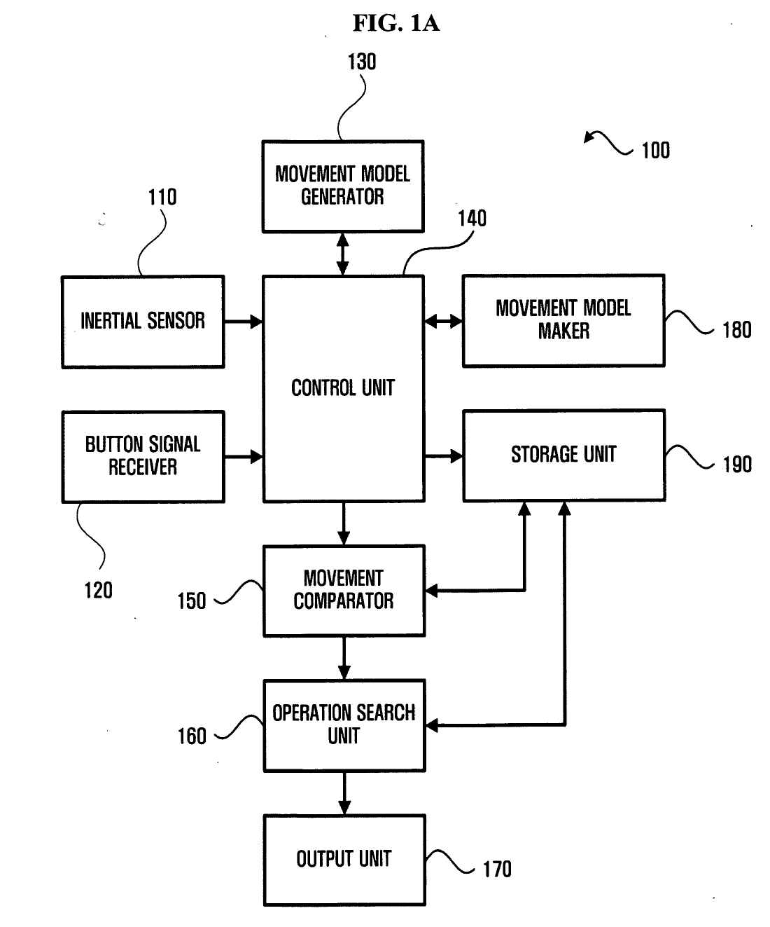

FIG. 1A illustrates an apparatus/system 100 for controlling an operation through an instructional movement, according to an embodiment of the present invention. The apparatus 100 may include an inertial sensor 110, a button signal receiver 120, a movement model generator 130, a control unit 140, a movement comparator 150, a operation search unit 160, an output unit 170, a movement probability distribution maker 180, and a storage unit 190, for example.

Main processes of the apparatus 100 may be movement registration and operation control based upon input instructional movements, for example.

The movement registration may be a process including analyzing instructional movements applied to the apparatus 100, generating a movement model, and storing the movement model corresponding to a particular predetermined operation. When a user applies the same pattern of instructional movement to the apparatus 100 one or more times, for example, a movement model may be generated through a learning process.

To register the movement, the user may input an instructional movement first and then select a corresponding operation to control by the same or the operation may be selected first and then the corresponding instructional movement or movement model may be input.

Meanwhile, the control of the operation may be based on any of a plurality of stored movement models, e.g., for controlling the operation based upon different input instructional movements compared to the corresponding stored movement models. For this, the apparatus 100 makes a probability distribution determination with respect to each input instructional movement compared to a plurality of movement models, i.e., the magnitude of inertial force to the probability distribution can be used to calculate a probability value. Thereafter, the operation with a corresponding movement model having a highest probability value among the plurality of stored movement models is controlled by the input instruction movement.

Since a movement model may be generated through learning, during the movement registration, even when the user inputs instructional movements having minor errors, e.g., to the apparatus 100, to control a particular operation, the proper operation can be controlled.

According to an embodiment of the present invention, the inertial sensor 110 senses movement, and may include at least one of an acceleration sensor and an angular velocity sensor. Here, the inertial sensor 110 may express inertial force of a mass generated due to acceleration or angular velocity in deformation of an elastic structure and express the deformation of the elastic structure in an electrical signal using appropriate sensing and signal processing schemes.

Here, the inertial sensor 110 may also be included within the apparatus 100, separate from the apparatus 100, or included in a separate device that can transmit an electrical signal to the apparatus 100 through a wired or wireless communication, for example.

The inertial sensor 110 may sense two dimensional movements, such as curvilinear movement and rectilinear movements, and three dimensional movements combining a curvilinear movement and a rectilinear movement, for example. In other words, according to an embodiment of the present invention, the inertial sensor 110 generates an electrical signal for a single two- or three-dimensional basic movement and a user can generate the instructional movements by having a singular movement or by combining a plurality of basic movements.

Here, movements can be distinguished in the time domain in such a way that a start or endpoint of the movement can be determined, e.g., according to an input of a predetermined button or absence of movement for a predetermined period of time, for example.

The button signal receiver 120 may receive a button input signal, with the button input signal being a movement registration signal or an operation control signal, for example. As another example, two separate buttons may be provided for the respective signals or a single button may be switched to sequentially generate the two signals. Alternatively, the movement registration signal or the operation control signal may be generated when a user selects a particular item in a displayed menu.

Here, the movement registration signal may prompt the movement model generator 130 to generate a movement model for an input instructional movement, and the operation control signal may prompt the output unit 170 to produce a signal allowing an operation corresponding to the movement model to be controlled.

The button input signal can be transmitted to the control unit 140. When the button input signal is the movement registration signal, the control unit 140 may store a movement model generated by the movement model generator 130, e.g., in the storage unit 190, corresponding to a particular operation. Here, the control unit 140 may control the movement comparator 150 to apply the magnitude of inertial force of a sensed movement to a probability distribution made using movement models, e.g., stored in the storage unit 190, and determine whether a probability value obtained through the application exceeds a predetermined threshold value. When the probability value exceeds the predetermined threshold value, that is, when a movement model similar to the sensed movement exists in the stored movement models, the control unit 140 may control the output unit 170 to output an error message output signal, for example. Here, the apparatus 100 may output an error message using a display unit or a speaker.

Meanwhile, when the button input signal is the operation control signal, the control unit 140 may control the movement comparator 150 to apply the magnitude of inertial force of a sensed movement to a probability distribution made using movement models, e.g., stored in the storage unit 190, and determine whether a probability value obtained through the application exceeds a predetermined threshold value. When one or more probability values exceed the predetermined threshold value, that is, when one or more movement models are found similar to the sensed movement, the control unit 140 may control the output unit 170 to output a operation control signal corresponding to one of the movement models having a highest probability value, among the movement models having probability values exceeding the predetermined threshold value. Then, the apparatus 100 may control the operation according to the operation control signal, as desired, e.g., to answer a query or input a command.

The movement model generator 130 may analyze the movement sensed by the inertial sensor 110 and generate a movement model used to for the probability distribution of the input instructional movement, i.e., the sensed movement.

A movement model may be a set of feature information in movement information sensed by the inertial sensor 110 and may include a one-, two-, or three-dimensional movement patterns, for example, of the apparatus 100, or the inertial sensor 110 is not with the apparatus 100.

The movement model may include at least one among a number of segments defined by predetermined points in a movement sample input to generate the movement model, a correlation between a plurality of movement samples, and a linear relationship matrix including linear variable coefficients, e.g., determined through learning, to reduce differences between movement samples. Here, the correlation may be expressed using a covariance matrix, for example. In addition, the correlation may include a variance of the movement samples at a border of a predetermined point and an overall variance of the movement samples which has been pre-generated through application of a predetermined weight.

The movement model generated by the movement model generator 130 may be transmitted to the control unit 140, and the control unit 140 may store the movement model in the storage unit 190 corresponding to a particular operation, for example.

A user can operate the apparatus 100 to generate a single movement model based on a single movement or through a plurality of movements. For example, to generate a movement model for a triangular-shaped movement, a triangular movement model may be generated by inputting a single continuous movement having a triangular shape. Alternatively, a plurality of movements may be made to generate a triangular-shape may be input so that an overall triangular movement model statistically appearing in the input movements is generated.

Since movements input by a user, in a particular pattern, may not be exactly the same, movement input may be made several times in the particular pattern so that the movement model generator 130 can generate a movement model, representing a particular movement with high probability, through learning. As a result, a determination of similarity between a movement model and a sensed movement can be more exact.

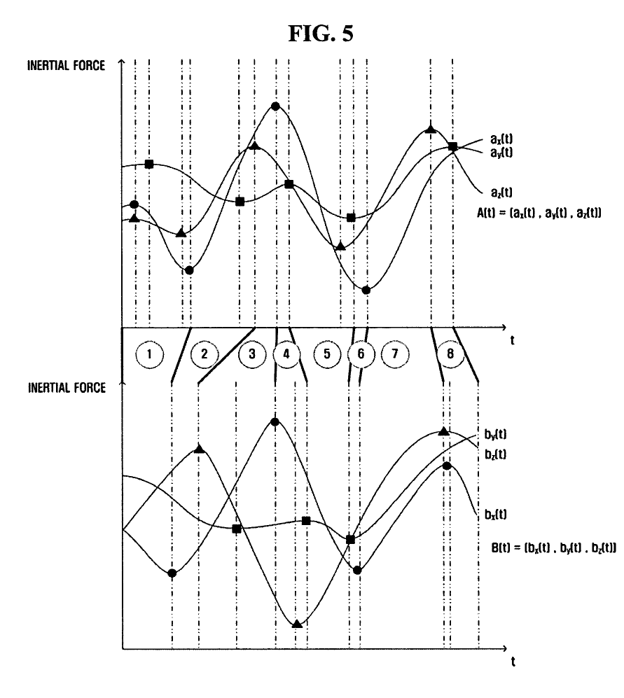

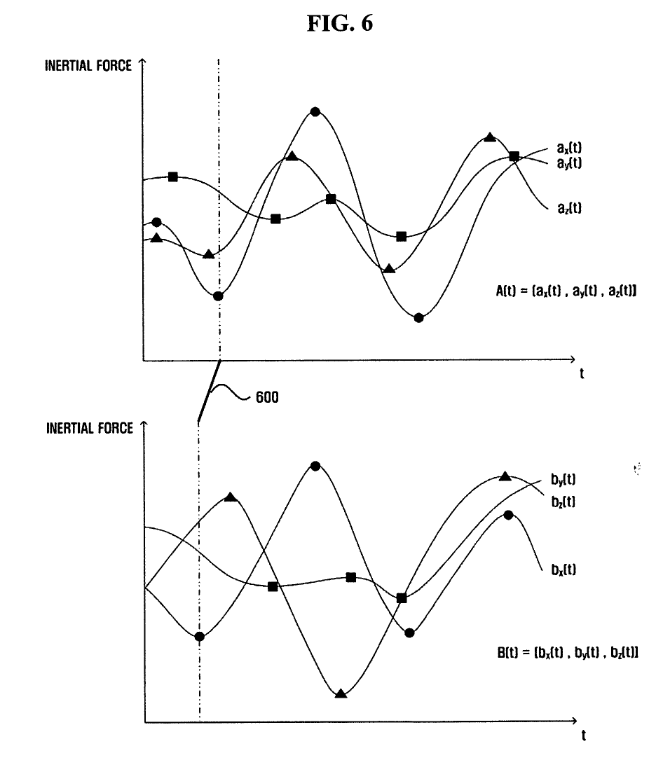

The generating of a movement model will be described in greater detail with reference to FIGS. 5 and 6 further below.

According to an embodiment of the present invention, the storage unit 190 may store at least one of a movement model, and an operation control signal corresponding to the movement model. As an example, a unique identifier or number may be allocated to the movement model when the movement model is stored.

The operation control signal may include a signal prompting the apparatus 100 to perform at least one operation, e.g., capable by the apparatus 100, and/or any alternate operations set by a user.

For example, when the apparatus 100 is a mobile phone, operation control signals for respectively performing a menu display, address book display, and short dialing, e.g., performable by the apparatus 100 when manufactured, may be stored in the storage unit 190. In addition, an operation control signal for controlling a particular operation designated by a user, combining a plurality of processes provided within the apparatus 100, may similarly be stored in the storage unit 190. An operation control signal for controlling a particular operation, set by combining a plurality of processes, may similarly be a combination of operation control signals for each controlling the corresponding plurality of operations, respectively.

Here, according to an embodiment of the present invention, the user may store his/her speech or other sound data corresponding to a movement model so that the speech or other sound data can be output according to the sensed movement of the apparatus 100.

The storage unit 190 may be a module allowing the input and output of information, such as a hard disc, flash memory, a compact flash (CF) card, a secure digital (SD) card, a smart media (SM) card, a multimedia card (MMC), or a memory stick, for example. The storage unit 190 may also be included within the apparatus 100, as a separate device, or in a separate device.

The movement probability distribution maker 180 makes a probability distribution of a particular sensed movement using stored movement models.

The stored movement models may have information for making the probability distribution of movement and information for a weight set used in a neural network and a weight set used in a support vector machine, for example.

Accordingly, the movement comparator 150 can make a determination of similarity between each of the stored movement models and a currently sensed movement.

The probability distribution may be transmitted to the control unit 140. Then, the control unit 140 may transmit the probability distribution and the currently sensed movement to the movement comparator 150, where the movement comparator 150 compares the currently sensed movement with each of all movement models, e.g., stored in the storage unit 190.

The movement comparator 150 may compare similarities between the currently sensed movement and every, for example, movement model stored in the storage unit 190.

For this process, the movement comparator 150 may calculate a probability value by applying the inertial force of the currently sensed movement to the probability distribution with respect to each of the movement models. Similarities between the currently sensed movement and the individual movement models can be compared by comparing probability values calculated with respect to the individual movement models.

The movement comparator 150 sends to the operation search unit 160 a unique number, for example, allocated to a movement model having a highest probability value among the calculated probability values.

The operation search unit 160 searches for an operation control signal corresponding to the movement model having the unique number received from the movement comparator 150. The operation search unit 160 may then transmits the found operation control signal to the output unit 170, which outputs the operation control signal.

According to the operation control signal, output from the output unit 170, the apparatus 100 may control the operation(s) corresponding to the operation control signal. For example, when the apparatus 100 is a mobile phone, an operation such as menu display, address book display, or short dialing that may be inherently provided in the mobile phone, or an operation set by a user, can be controlled.

The control unit 140 may control the movement model generator 130, the inertial sensor 110, the button signal receiver 120, the storage unit 190, the movement comparator 150, the operation search unit 160, the output unit 170, and the movement probability distribution maker 180, and potentially, the entire operations of the apparatus 100, for example.

FIG. 1B illustrates a movement model generator 130, such as that illustrated in FIG. 1A, according to an embodiment of the present invention. The movement model generator 130 may include a movement sample input unit 132, a segment creator 134, a correlation extractor 136, and a linear relationship extractor 138, for example, noting that alternative embodiments are equally available.

The movement sample input unit 132 may receive a movement sample, with the movement sample potentially being an electrical signal corresponding to the movement sensed by the inertial sensor 110 or movement information transmitted from a separate device that stores the electrical signal in a predetermined format, for example.

The segment creator 134 may divide the input movement sample into segments, e.g., based on predetermined points. As described above, a point where the direction of movement changes on each axis in a space included in the movement sample may be considered a border defining segment.

When a plurality of movement samples are input, the correlation extractor 136 extracts correlation between the movement samples with respect to each segment. The correlation may be expressed by a covariance matrix and include a variance of the movement samples at a border and an overall variance of the movement samples which has been pre-generated through application of a predetermined weight, for example.

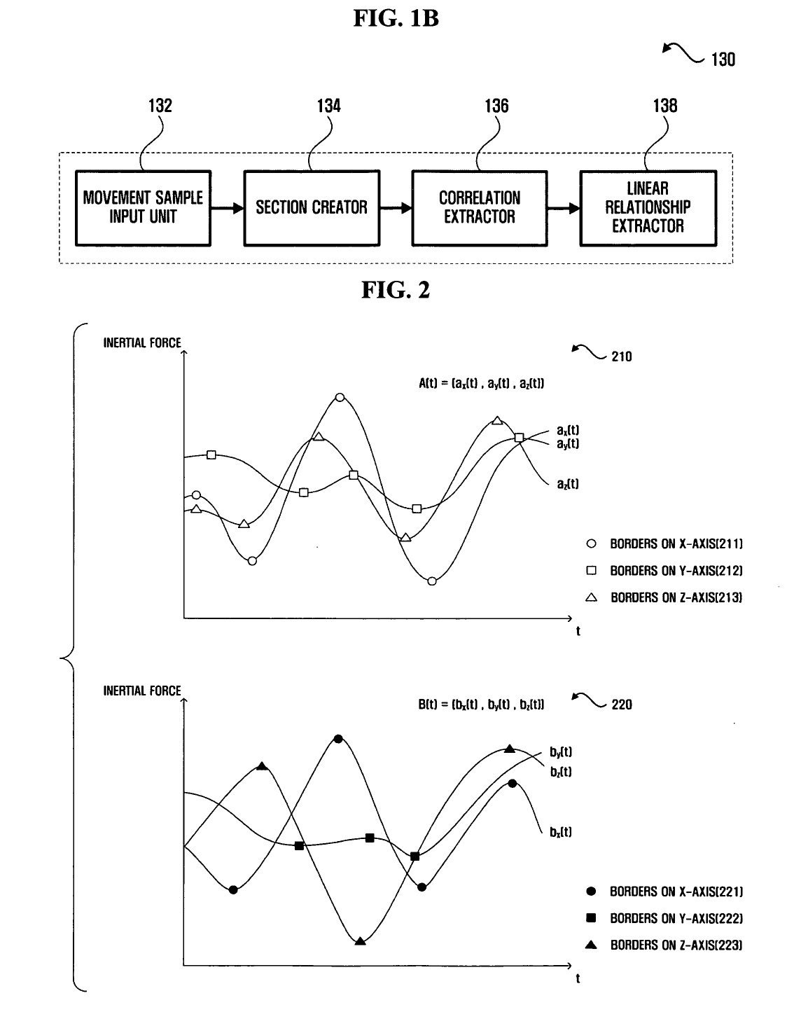

The linear relationship extractor 138 may extract a linear relationship matrix, including linear variable coefficients determined through learning, to reduce a difference between movement samples. Correspondingly, FIG. 2 illustrates first and second movement samples 210 and 220, according to an embodiment of the present invention.

Each of the first and second movement samples 210 and 220 include movement information for expressing a particular figure. When the changes in the movement, i.e., inertial force input by a user, are converted into an electrical signal, the electrical signal may be the first or second movement sample 210 or 220, for example.

In detail, the user may input movement describing a particular figure to the apparatus 100. The input movement may then be sensed and converted into an electrical signal by the inertial sensor 110, and in this example, the electrical signal may be the first and second movement sample 210 or 220.

The user may input a plurality of movements describing a particular figure to the apparatus 100. In this case, a plurality of the first and second movement samples 210 and 220 have been input and the apparatus 100 may generate a more general movement model with respect to the particular figure based on the plurality of the first and second movement samples 210 and 220.

As illustrated in FIG. 2, the first and second movement samples 210 and 220 can be expressed based on the magnitude of inertial force changing along a time axis. The magnitude of inertial force may be identified along each of axes, i.e., an X-axis, a Y-axis, and a Z-axis in space. In other words, each of the first and second movement samples 210 and 220 may be expressed by the changes in magnitudes of inertial force in only one dimension or in two or more dimensions.

Here, the inertial force is a physical quantity applied to the apparatus 100 and includes a physical quantity generated by acceleration or angular velocity, for example.

More particularly, the two graphs of FIG. 2, corresponding to the first and second movement samples 210 and 220, respectively, express a single FIGURE, in which inertial force is defined in three dimensions over time.

When movement is input, its electrical signal is analyzed, and the first and second movement samples 210 and 220 are generated. The apparatus 100 may divide each of the first and second movement samples 210 and 220 into predetermined segments. The segments in the first and second movement samples 210 and 220 have been defined by borders 211, 212, 213, 221, 222, and 223 corresponding to predetermined points, where the direction of an inertial force changes on all of the axes in space included in the first and second movement samples 210 and 220.

In other words, the magnitude of inertial force changes along an axis in space over time. A point where the direction of the inertial force changes, i.e., a point where increasing inertial force starts decreasing or decreasing inertial force starts increasing may become borders, e.g., borders 211, 212, 213, 221, 222, or 223.

After each of the movement samples 210 and 220 is divided into segments, the apparatus 100 makes matches between the borders 211, 212, and 213 in the first movement sample 210 between the borders 221, 222, and 223 in the second movement sample 220 and compares the magnitude of inertial force at a border in the first movement sample 210 and the magnitude of inertial force at a border in the second movement sample 220, in which the two borders are matched with each other, to obtain differences in the magnitude of inertial force between borders in the respective matches. With respect to segments having small differences therebetween, the first and second movement samples 210 and 220 can be matched with each other and the number of segments corresponding to each other can be checked.

Here, the first movement sample 210, A(t), and the second movement sample 220, B(t), may be defined as follows in Equation (1).
A(t)=(aₓ(t),a_{y}(t),a_{z}(t))
B(t)=(b(t),b_{y}(t),b_{z}(t)) Equation (1):

As is set forth by Equation (1), here, the first and second movement samples 210 and 220 have a three-axis component (inertial force) in space versus time “t”.

Comparison of the magnitude of inertial force between the first movement sample 210, A(i), and the second movement sample 220, B(r) at the borders 211, 212, 213, 221, 222, and 223 may be performed using the following Equation (2).
D(1,1)=Match(A(1),B(1))
D(i,r)=Match(A(i), B(r))+min{D(i−1,r−1),D(i−1,r)+α,D(i,r−1)+P}(i,j>1), Equation (2):

Here, D(i,r) indicates a difference between the magnitude of inertial force at one border “i” among the borders (211, 212, or 213) in the first movement sample 210 and the magnitude of inertial force at one border “r” among the borders (221, 222, or 223) in the second movement sample 220, and “α” and “β” indicate constants determined through experiments, for example. In other words, the difference between the magnitude of inertial force at the border “i−1” and the magnitude of inertial force at the border “r” and the difference between the magnitude of inertial force at the border “i” and the magnitude of inertial force at the border “r−1” will be reflected to a difference between the first movement sample 210 and the second movement sample 220 is determined by the constants “α” and “β”.

In addition, “Match(A(i),B(r))” may be defined according to Equation (3).

$$Equation ( 3 ) \text{:} \\ \begin{matrix}Match ( A ( i ) , B ( j ) ) = ‖ A ( i ) - B ( j ) ‖ \\ = \sqrt{\begin{matrix}{( {a}_{x} ( i ) - {b}_{x} ( j ) )}^{2} + \\ {( {a}_{y} ( i ) - {b}_{y} ( j ) )}^{2} + \\ {( {a}_{z} ( i ) - {b}_{z} ( j ) )}^{2}\end{matrix}} .\end{matrix}$$

In other words, difference between the magnitude of inertial force at each border 211, 212, or 213 in the first movement sample 210 and the magnitude of inertial force at each border 221, 222, or 223 in the second movement sample 220 may be calculated using a difference between each spatial axis component in the first movement sample 210 and each spatial axis component in the second movement sample 220.

As is set forth by Equation (2), differences between the magnitude of inertial force at each border 211, 212, or 213 in the first movement sample 210 and the magnitude of inertial force at each border 221, 222, or 223 in the second movement sample 220 may be calculated using not only the difference between a current border in the first movement sample 210 and the current border in the second movement sample 220 but also by using a minimum value among the difference “D(i−1,r−1)” between the magnitude of inertial force at a previous border in the first movement sample 210 and the magnitude of inertial force at a previous border in the second movement sample 220, the difference “D(i−1,r)” between the magnitude of inertial force at the previous border in the first movement sample 210 and the magnitude of inertial force at the current border in the second movement sample 220, and the difference “D(i,r−1)” between the magnitude of inertial force at the current border in the first movement sample 210 and the magnitude of inertial force at the previous border in the second movement sample 220. In other words, the difference between the magnitudes of inertial force at the respective current borders is influenced by the magnitudes of inertial force at their previous borders.

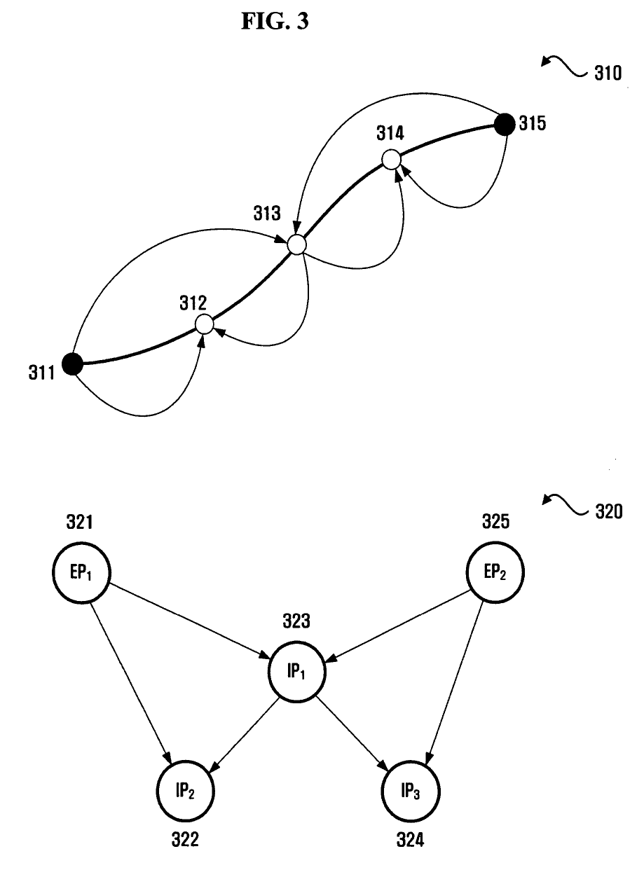

FIG. 3 illustrates examples where a midpoint has been determined based on endpoints of a segment, according to an embodiment of the present invention. When a line connecting a first endpoint 311 and a second endpoint 315 exists in a single segment, the position of the first midpoint 313 can be determined by the positions of the respective first and second endpoints 311 and 315 (310). In other words, when the positions of the first and the second endpoints 311 and 315 are known, the position of the first midpoint 313 can be estimated with only a small error.

In addition, a second midpoint 312, existing between the first endpoint 311 and the first midpoint 313, may be estimated from the first endpoint 311 and the first midpoint 313 and a third midpoint 314, existing between the second endpoint 315 and the first midpoint 313, may be estimated from the second endpoint 315 and the first midpoint 313. Similarly, a midpoint (not shown), existing between the first endpoint 311 and the second midpoint 312, may be estimated from the first endpoint 311 and the second midpoint 312. The more repetition of such estimation is performed, the more detailed of a midpoint can be obtained.

Reference numeral 320 denotes a Bayesian network describing that the position of a midpoint is estimated from two reference positions. Reference numeral 321 denotes a first endpoint EP₁; reference numeral 325 denotes a second endpoint EP₂; and reference numerals 323, 322, and 324 denote midpoints IP₁, IP₂, and IP₃, respectively. The IP, 323 is estimated from the EP₁ 321 and the EP₂ 325; the IP₂ 322 is estimated from the EP₁ 321 and the IP₁ 323; and the IP₃ 324 is estimated from the IP₁ 323 and the EP₂ 325.

Estimating the position of a midpoint from two reference positions may be defined by Gaussian distribution expressed by the following Equation (4)

$$Equation ( 4 ) \text{:} \\ P ( {P}_{i} \vert {P}_{j} , {P}_{k} ) = {( 2 π )}^{- \frac{1}{2}} {\vert \sum \vert}^{- \frac{1}{2}} exp ( - \frac{1}{2} {( {P}_{i} - μ )}^{T} {\sum }^{- 1} ( {P}_{i} - μ ) )$$

Here, Pᵢ indicates a midpoint, Pⱼ and Pₖ respectively indicate endpoints, and “μ” indicates a conditional mean. The conditional mean “μ” may be defined by the following Equation (5).

$$Equation ( 5 ) \text{:} \\ μ = {{W}_{i} [ \frac{( {P}_{j} + {P}_{k} )}{2} , 1 ]}^{T}$$

In other words, the conditional mean may be calculated by multiplying a value, calculated by performing linear interpolation on two endpoints, by a predetermined weight and adding a predetermined constant to the multiplication result.

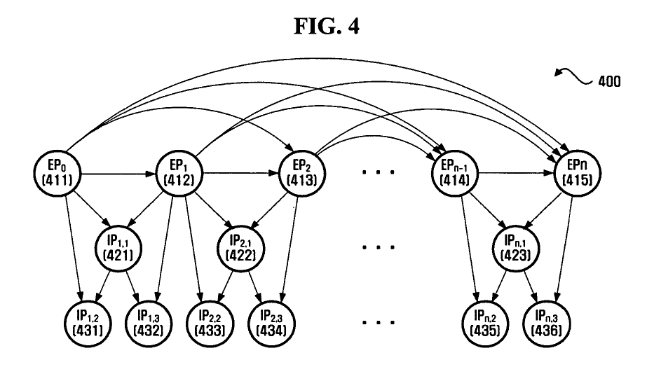

FIG. 4 illustrates a relationship between endpoints of different segments, according to an embodiment of the present invention, and shows a Bayesian network 400 describing that a latter endpoint is estimated from a former endpoint.

The Bayesian network 400 includes an arc two connecting nodes. In the Bayesian network 400, a node corresponds to a probability variable and an arc expresses a relationship between probability variables.

For example, the position of an endpoint EP₁ 412 depends on the position of an endpoint EP₀ 411, and the position of the endpoint EP₂ 413 depends on the positions of the endpoint EP₀ 411 and the endpoint EP₁ 412. Consequently, the position of an endpoint EPₙ 415 depends on the positions of the endpoint EP₀ 411 through the endpoint EPₙ₋₁ 414.

Thus, determined endpoints 411 through 415 may be used to estimate the positions of midpoints, as illustrated in FIG. 3. In other words, the position of a latter midpoint depends on the position of a former endpoint and the position of a former midpoint.

Here, each of first midpoints 421, 422, and 423, generated based on two endpoints, may be generated at a midpoint in a time domain between the two endpoints. Similarly, each of second midpoints 431 through 436, generated based on a single endpoint and a single first midpoint, may be generated at a midpoint in a time domain between the endpoint and the first midpoint.

Thus generated midpoints recursively serve as another border with respect to a movement model. The generation of a midpoint is continued until the number of midpoints is equal to the number of all movement samples, for example.

To define endpoints and midpoints, a movement model may be generated and stored with respect to each of the points. The stored movement model may be referred to in order to determine movement similarity.

A movement model may include the number of pairs of segments corresponding to each other between movement samples, a covariance matrix expressing the distribution of movement samples at a border between segments, and linear variable coefficients determined through learning to reduce a difference between movement samples.

FIG. 5 illustrates a correspondence of segments between movement samples, according to an embodiment of the present invention.

As described above, segments of a movement sample may be determined by points where the direction of inertial force (i.e., acceleration or angular velocity) changes on each of spatial axes included in the movement sample.

Here, a difference in the magnitude of inertial force between a plurality of movement samples can be calculated using Equations (1) through (3), and therefore, segments in different movement samples may be matched with each other.

FIG. 5 illustrates a state where segments in one movement sample are matched with segments in the other movement sample according to similarity therebetween. The number of pairs of segments corresponding to each other can be inferred from FIG. 5.

The number of pairs of segments corresponding to each other is an element of a movement model, based on which the apparatus 100 may make a probability distribution of movement.

FIG. 6 illustrates a particular corresponding border 600, between a plurality of movement samples, according to an embodiment of the present invention. A covariance Cov_{new} representing the distribution of movement samples at the border 600 can be expressed by the following Equation (6).
Cov_{new}(X)=βCov(X)+(1−β)Covₜₒₜₐₗ Equation (6):

Here, X denotes a matrix with respect to X-, Y-, and Z-axes describing each movement sample, Cov(X) is a covariance of the movement samples, and Covₜₒₜₐₗ is the mean of all covariances calculated at all borders. For Covₜₒₜₐₗ, a value of β between 0 and 1 may be calculated through experiments and applied to Equation (6), thereby determining the amount of reflection of covariance at a current point and covariance at a previous point. As described above, a new covariance may be obtained by summing the product of a covariance at a current border and a weight and the product of a mean covariance and a weight in order to increase the accuracy of covariance estimation with consideration of covariance at other borders since the number of movement samples may be small, e.g., two.

The covariance of the movement samples, Cov(X), can be expressed by the following Equation (7).

$$Equation ( 7 ) \text{:} \\ Cov ( X ) = \frac{1}{N} {\sum }_{j = 1}^{N} ( {X}_{j} - \overline{X} )$$

Here, Xⱼ denotes a matrix with respect to the X-, Y-, and Z-axes describing a j-th movement sample, N denotes a total number of movement samples input to generate a movement model, and X̅ denotes a matrix indicating means of the movement samples with respect to the X-, Y-, and Z-axes.

The covariance Cov_{new} representing the distribution of movement samples at the border 600 is an element of a movement model and may be used, e.g., by the apparatus 100, to make a probability distribution of a particular movement.

A linear variable “w”, determined through learning, to reduce a difference between a plurality of movement samples may be defined as “w” minimizing a value calculated by the following Equation (8).

$$\begin{matrix}Equation ( 8 ) \text{:} & \\ min \text{?} \text{?} \text{indicates text missing or illegible when filed} & \end{matrix}$$

Here, “y” denotes a matrix with respect to a three-dimensional axis describing a current movement sample, “x” denotes a matrix with respect to a three-dimensional axis describing a previous movement sample, M denotes a total number of movement samples, “n” is the number of previous time points influencing a current time point, and “w” is a linear variable, i.e., a weight for the three-dimensional axis. In other words, a current movement sample may be influenced by a previous movement sample and dependency therebetween is determined by a weight.

Linear variable coefficients, determined through learning, to reduce a difference between a plurality of movement samples are an element of a movement model and may be used, e.g., by the apparatus 100, to make a probability distribution of a particular movement.

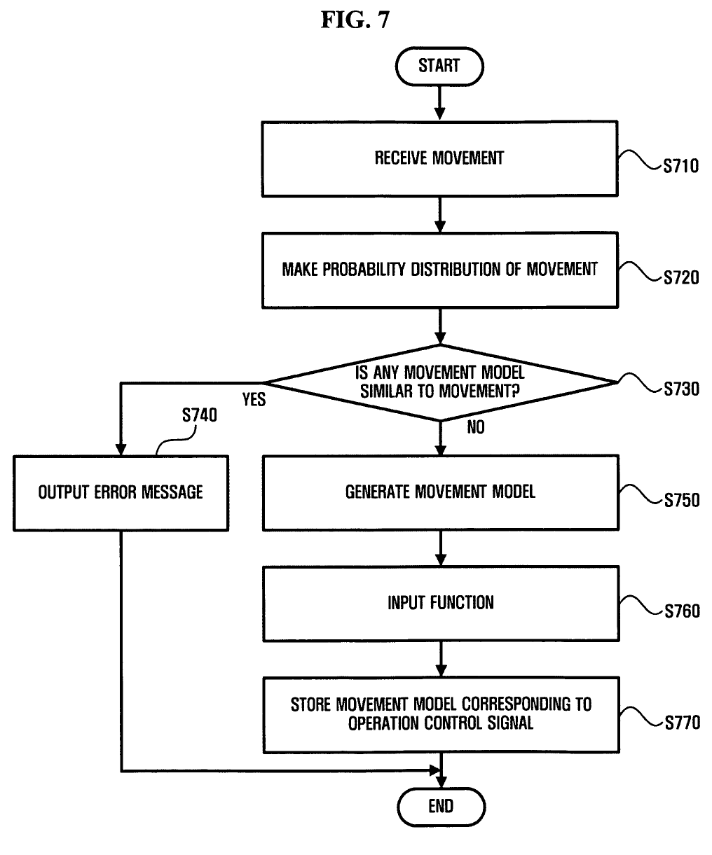

FIG. 7 illustrates a registering of a movement, according to an embodiment of the present invention.

In process S710, an apparatus may receive movement input, e.g., by a user. Here, a user can input the movement for registration, e.g., by selecting a button generating a movement registration signal from buttons provided in the apparatus. Alternatively, the apparatus may perform movement registration upon receiving, e.g., from the user, a selection command on a particular item in a menu displayed for the movement registration. The user may also input a name for the input movement.

The input movement may be sensed by an inertial sensor included in the apparatus, for example. The inertial sensor may include at least one of an acceleration sensor and an angular velocity sensor and express the inertial force of a mass generated due to acceleration or angular velocity in an electrical signal.

The user may input a two-dimensional movement, such as a rectilinear or curvilinear movement, and/or also input a three-dimensional movement, combining rectilinear and curvilinear movements.

In process S720, the apparatus may make a probability distribution of the input movement using stored movement models. In process S730, the apparatus determines whether the currently input movement is similar to any of the stored movement models, using the probability distribution. In other words, a probability value with respect to each of the movement models may be calculated by applying the magnitude of inertial force of the input movement to the probability distribution and determine whether the probability value exceeds a predetermined threshold value. These calculation and determinations may be performed with respect to all of the movement models, for example.

When a movement model similar to the input movement is found to exist, that is, when a probability value exceeds the predetermined threshold value, an error message may be output in process S740. For example, the apparatus may output a message “Registered movement. Please, input again.” in text or sound.

When no movement models similar to the input movement exists, a movement model corresponding to the input movement may be generated, in process S750. Here, the user may input a single movement having a particular figure or plurality of movements having the particular figure to generate a single movement model corresponding to the particular figure, for example.

Here, the movements repeatedly input for the particular figure can be learned by a movement model generator, e.g., included in the apparatus, to thereby generate a more general and reliable movement model.

After generating the movement model, an operation control selection may be made by the user, in process S760. For example, the apparatus may receive the indication of the operation corresponding to the movement model. To receive this indication of the operation, the apparatus may display a list of supported operations and may receive from the user a selection command on at least one among listed operations. In other words, the user may search the displayed list and select one (or more) operation to input a selection command or may select a particular button, e.g., provided in the apparatus, to input a selection command on a currently controlled operation.

In process S770, the apparatus may store the movement model corresponding to an operation control signal for controlling the selected operation. Here, a unique number may be allocated to the movement model, for example.

When the movement model is stored, the apparatus may display the figure of the input instructional movement to allow the user to identify the figure of the input instructional movement. For this operation, the apparatus may restore a trajectory of the input movement, convert the trajectory into coordinates, generate a figure according to the coordinates, and display the selected operation and the generated figure. Here, the coordinates include one-, two-, or three-dimensional coordinates, for example. In other words, the figure input by the user may be a one-, two-, or three-dimensional figure, for example.

Alternatively, the user may select an operation first, and then select to enter the instructional movement.

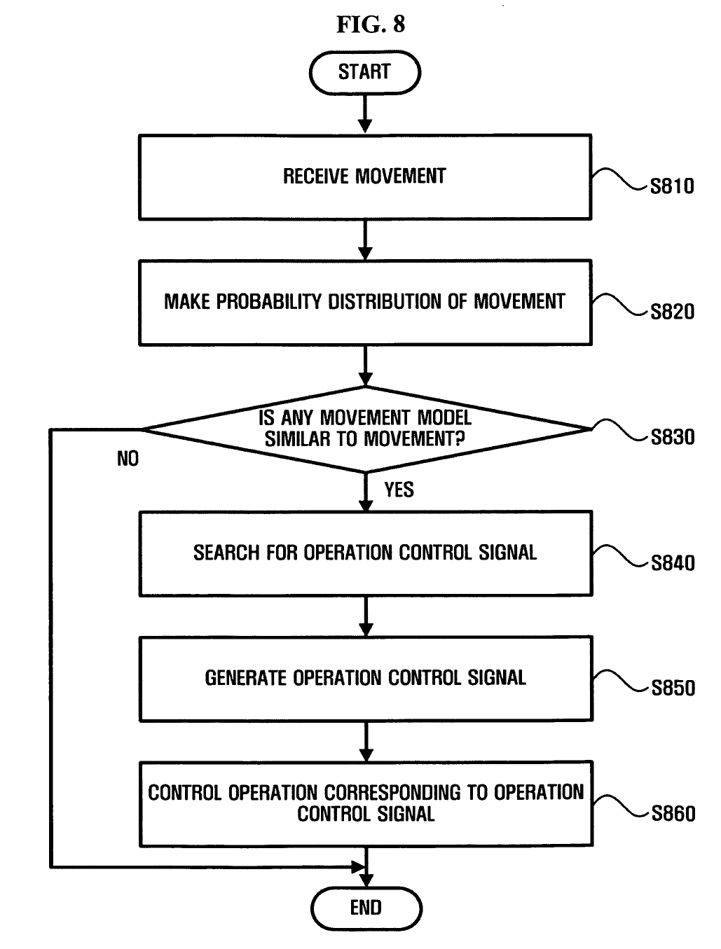

FIG. 8 illustrates a controlling an operation according to movement, according to an embodiment of the present invention.

In process S810, an apparatus may receive movement input by a user. Here, the user may input the movement for operation control by selecting a button generating an operating control signal from buttons provided in the apparatus, for example.

The input movement may be sensed by an inertial sensor, e.g., included in the apparatus. The inertial sensor may include at least one of an acceleration sensor and an angular velocity sensor and may express the inertial force of a mass generated due to acceleration or angular velocity in an electrical signal.

The user may input a two-dimensional movement, such as a rectilinear or curvilinear movement, and also input a three-dimensional movement combining rectilinear and curvilinear movements.

In process S820, a probability distribution may be made of the input movement using stored movement models. In process S830, whether the currently input movement is similar to any of the stored movement models may be determined using the probability distribution. In other words, a probability value may be calculated with respect to each of the movement models by applying the magnitude of inertial force of the input movement to the probability distribution. Whether the probability value exceeds a predetermined threshold value may the be determined.

These calculation and determinations may be performed with respect to all of the movement models. When any movement model similar to the input movement exists, that is, when there is a probability value exceeding the predetermined threshold value, in process S840, a movement model having a highest probability value among probability values exceeding the predetermined threshold value may be selected and an operation control signal corresponding to the selected movement model may be searched for, e.g., using a unique number allocated to the movement model. In process S850, the operation control signal may then be output.

In process S860, the operation may be controlled according to the operating control signal. As only an example, when the apparatus is a mobile phone, the apparatus may control an operation, such as menu display, address book display, or short dialing inherently provided therein, or another operation set by the user.

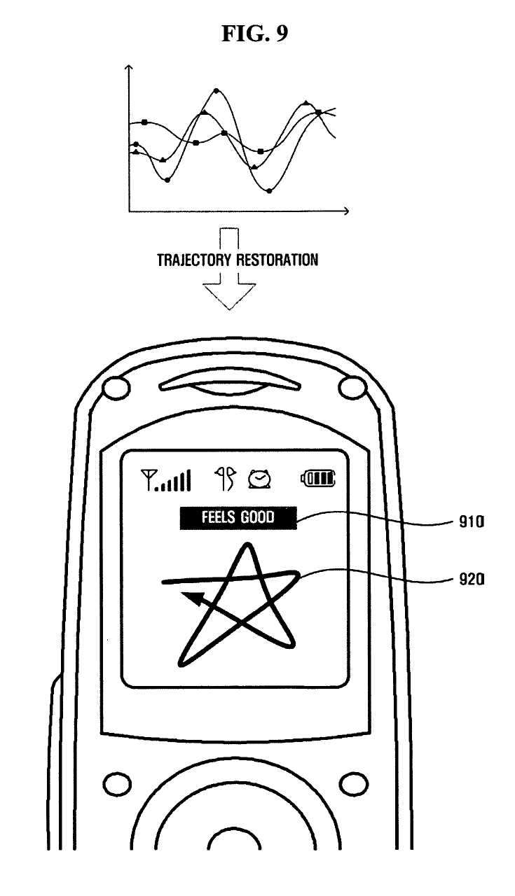

FIG. 9 illustrates an example in which a figure of a registered movement is displayed, according to an embodiment of the present invention.

When controlling an operation corresponding to a registered movement, a FIG. 920 of the registered movement may be displayed. In other words, the FIG. 920 of movement, selected by a user, may be displayed to allow the user to view the FIG. 920, whereby the user can memorize the figure of the movement for operating a certain operation, or potentially confirm the same. In addition, after time passes since the user may have registered movement corresponding to a particular operation, it may help the user to remember the registered movement.

Here, as only an example, a name 910 of the movement may be displayed together with the FIG. 920 thereof, whereby the user can recognize the FIG. 920 based on the name 910.

To display the FIG. 920 of movement, trajectory restoration may also be performed. The apparatus/system 100, illustrated in FIG. 1A, may further include a trajectory restoration unit 1000 to perform the trajectory restoration, for example.

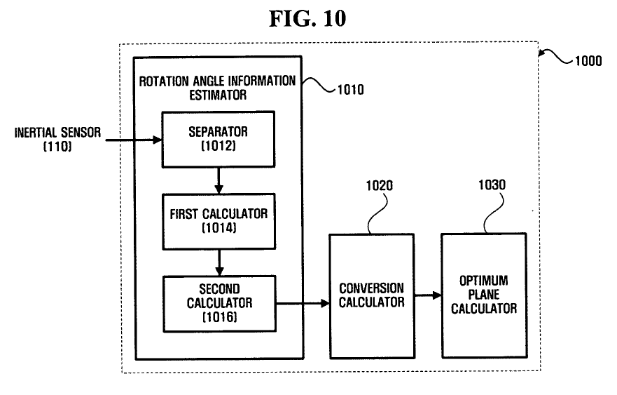

FIG. 10 illustrates such a trajectory restoration unit 1000, according to an embodiment of the present invention. The trajectory restoration unit 1000 may include a rotation angle information estimator 1010, a conversion calculator 1020, and an optimum plane calculator 1030, for example.

The apparatus 100, for example, may perform trajectory restoration using acceleration only among movement components. Hereinafter, in this example, it will be assumed that only acceleration information is sensed by the inertial sensor 110, and trajectory restoration is performed.

The inertial sensor 110 may be provided corresponding to three X-, Y-, and Z-axes of a body frame based on three X-, Y-, and Z-axes of movements, e.g., of the apparatus 100. The inertial sensor 110 may detect and output movement acceleration information, pre-movement acceleration information, and post-movement acceleration information, e.g., based on movement of the apparatus 100.

Movement acceleration information, pre-movement acceleration information, and post-movement acceleration information will be defined in greater detail below.

To restore a trajectory of movement of the apparatus 100, an assumption needs to be made that the apparatus 100 may not move right before and after movement is applied to the apparatus 100. Accordingly, the inertial sensor 110 may detect pre-movement acceleration information and post-movement acceleration information with respect to the movement applied to the apparatus 100.

Pre-movement acceleration information indicates acceleration information of the apparatus 100, right before movement is applied to the apparatus 100. Post-movement acceleration information indicates acceleration information of the apparatus 100 right after movement is applied to the apparatus 100, and movement acceleration information indicates acceleration information based on movement applied by a user to the apparatus 100.

The rotation angle information estimator 1010 may estimate rotation angle information based on pre-movement acceleration information and post-movement acceleration information output from the inertial sensor 110, for example. The rotation angle information estimator 1010 may also include a first calculator 1014 and a second calculator 1016.

The first calculator 1014 may receive pre-movement acceleration information and post-movement acceleration information from the inertial sensor 110.

Here, the first calculator 1014 may calculate “φ” and “θ” among pre-movement rotation angle information using a predetermined process based on the pre-movement acceleration information. The pre-movement rotation angle information may be rotation angle information corresponding to the pre-movement acceleration information.

Similarly, the first calculator 1014 may calculate “φ” and “θ” among post-movement rotation angle information using a predetermined process based on the post-movement acceleration information. Here, the post-movement rotation angle information may be rotation angle information corresponding to the post-movement acceleration information.

When X-, Y-, and Z-axes are defined as coordinate axes, e.g., of the body frame of the apparatus 100, X-axis acceleration information may be represented with A_{bx}, Y-axis acceleration information may be represented with A_{by}, Z-axis acceleration information may be represented with A_{bz}, rotation angle information with respect to a Z₀-axis may be represented with “ψ”, and rotation angle information with respect to a Y₁-axis obtained after a Y₀-axis is rotated by “ψ” may be represented with “0”. Here, rotation angle information with respect to an X₂-axis obtained after an X₀-axis is rotated by “ψ” and “θ” is represented with “φ” and may be expressed by the following Equation (9).

$$\begin{matrix}Equation ( 9 ) \text{:} & \\ ϕ = {tan}^{- 1} ( \frac{{A}_{by}}{{A}_{bz}} ) & \end{matrix}$$

The rotation angle information “θ” with respect to the Y₁-axis may be expressed by the following Equation (10).

$$\begin{matrix}Equation ( 10 ) \text{:} & \\ θ = {tan}^{- 1} ( \frac{{A}_{bx}}{\sqrt{{A}_{by}^{2} + {A}_{bz}^{2}}} ) & \end{matrix}$$

When Equations (9) and (10) are used, “φ” and “θ”, among the rotation angle information, can be calculated from acceleration information obtained while the apparatus 100 does not move.

Here, the second calculator 1016 may receives “φ” and “θ” among the pre-movement rotation angle information calculated by the first calculator 1014 and receive “φ” and “θ” among the post-movement rotation angle information calculated by the first calculator 1014.

The second calculator 1016 may calculate rotation angle information “φ” of the movement using a predetermined process based on “φ” among the pre-movement rotation angle information and “φ” among the post-movement rotation angle information.

The second calculator 1016 may also calculate rotation angle information “θ” of the movement using a predetermined process based on “θ” among the pre-movement rotation angle information and “θ” among the post-movement rotation angle information.

When a time right before the movement is represented with “t₁”, a time right after the movement is represented with “t₂”,

$$\frac{ϕ ( {t}_{2} ) - ϕ ( {t}_{1} )}{{t}_{2} - {t}_{1}}$$

is represented with “a”, and −at₁+φ(t₁) is represented with “b”, φ(t) among the movement rotation angle information may be expressed by the following Equation (11).
φ(t)=at+b Equation (11)

When a time right before the movement is represented with “t₁”, a time right after the movement is represented with “t₂”,

$$\frac{θ ( {t}_{2} ) - θ ( {t}_{1} )}{{t}_{2} - {t}_{1}}$$

is represented with “c”, and “θ” is represented with “d”, θ(t) among the movement rotation angle information may be expressed by the following Equation (12).
θ(t)=ct+d Equation (12):

The conversion calculator 1020 may receive the movement acceleration information from the inertial sensor 110 and the movement rotation angle information estimated by the rotation angle information estimator 1010 and calculate speed information and position information of the movement in a navigation frame based on the received information.

The optimum plane calculator 1030 projects the position information output from the conversion calculator 1020 onto a two-dimensional virtual optimum plane and calculates a coordinate value. The coordinate value calculated by the optimum plane calculator 1030 is transmitted to the control unit 140, for example. Then, the control unit 140 may display a figure of the movement through a display unit provided in the apparatus 100.

In addition, the rotation angle information estimator 1010 may further include a separator 1012.

The separator 1012 may receive the movement acceleration information from the inertial sensor 110 and separate acceleration information based on the movement of the apparatus 100, for example, and acceleration information based on gravity acceleration from the movement acceleration information using a predetermined method.

To perform the predetermined method, the separator 1012 may include a low pass filter, for example.

Generally, acceleration information based on gravity acceleration exists in a lower frequency band than acceleration information based on movement itself.

Accordingly, when the separator 1012 includes a low pass filter, the acceleration information based on gravity acceleration is filtered by the separator 1012.

According to an embodiment of the present invention, the first calculator 1014 and the second calculator 1016 receive the acceleration information based on gravity acceleration and calculate movement rotation angle information using the acceleration information based on gravity acceleration and Equations (9) and (10).

Generally, in a state where an object stops, there is no movement and the object is influenced only by gravity. Accordingly, the acceleration information based on gravity acceleration among the movement acceleration information corresponds to a stop state.

As described above, embodiments of the present invention provide one or more aspects and benefits.

Firstly, since a movement model generated based on at least one movement may be stored corresponding to a particular operation and similarity between the stored movement model and input instructional movement by a user thereafter may be determined. Movement similar to the stored movement model as well as the same movement as the stored movement can thus be recognized.

Secondly, since a movement model is generated through a learning process, the movement model can be generated with only a small number of movement samples.

Thirdly, since a user can register his/her movements, an existing figure of movement for operation control can be changed into a movement figure made by the user. Accordingly, the user can register movements having figures that he/she can easily memorize and draw.

In addition to the above described embodiments, embodiments of the present invention can also be implemented through computer readable code/instructions in/on a medium, e.g., a computer readable medium. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. The media may also be a distributed network, so that the computer readable code is stored/transferred and executed in a distributed fashion.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A system for controlling an operation according to movement, comprising:
a movement probability distribution maker to make a probability distribution of a sensed movement using a plurality of stored movement models;
a movement comparator to determine similarity between movement models, of the plurality of stored movement models, and the sensed movement by a movement sensor using the probability distribution; and
a controller to control an operation corresponding to a movement model, of the movement models, according to the determined similarity.

2. The system of claim 1, further comprising an output unit to output an operation control signal for controlling the operation.

3. The system of claim 2, wherein the operation control signal comprises a signal for operating at least one among operations inherently provided in an apparatus and operations definable by a user.

4. The system of claim 1, further comprising an inertial sensor to obtain the sensed movement.

5. The system of claim 4, wherein the initial sensor, the movement probability distribution maker, the movement comparator, and the controller are embodied in a single apparatus body.

6. The system of claim 4, wherein the inertial sensor comprises at least one of an acceleration sensor and an angular velocity sensor.

7. The system of claim 1, wherein at least one movement model comprises at least one among a number of segments defined by predetermined points in a respective input movement sample to generate the at least one movement model, a correlation between a plurality of movement samples, and a linear relationship matrix including linear variable coefficients determined through learning to reduce a difference between movement samples.

8. The system of claim 7, wherein a method of expressing the correlation between the plurality of movement samples comprises a covariance matrix.

9. The system of claim 7, wherein the correlation comprises a variance of the plurality of movement samples at a border and within the segments corresponding to a predetermined point and an overall variance, of the plurality of movement samples, which has been pre-generated through application of a predetermined weight.

10. The system of claim 7, further comprising a movement model generator to generate the at least one movement model using a movement sample.

11. The system of claim 10, wherein the movement model generator comprises:
a movement sample receiver to receive the movement sample;
a segment creator to divide the received movement sample into segments using the predetermined points as borders;
a correlation extractor to extract the correlation between the plurality of movement samples; and
a linear relationship extractor to extract the linear relationship matrix including the linear variable coefficients.

12. The system of claim 10, wherein the movement model generator generates the at least one movement model using one among a one-dimensional movement sample, a two-dimensional movement sample, and a three-dimensional movement sample.

13. The system of claim 7, wherein the segments are defined by using, as borders, points where a direction of movement changes on each of axes in space included in the at least one movement sample.

14. The system of claim 1, wherein the movement comparator determines the similarity between the movement models and the sensed movement using a probability value obtained by applying a magnitude of inertial force of the sensed movement to the probability distribution.

15. The system of claim 1, further comprising a storage unit storing at least one of the movement models and an operation control signal, corresponding to a respective movement model, used by the controller for controlling the operation.

16. The system of claim 1, further comprising a button signal receiver to receive a button input signal for selectively controlling the system to generate a movement model and a button signal controlling the system to review the sensed movement and output a corresponding operation control signal corresponding to a respective movement model, used by the controller for controlling the operation.

17. A method of controlling an operation according to movement, the method comprising:
making a probability distribution of a sensed movement using a plurality of movement models;
determining similarity between movement models, of the plurality of movement models, and the sensed movement using the probability distribution; and
controlling an operation corresponding to a movement model, of the movement models, according to the determined similarity.

18. The method of claim 17, further comprising sensing the sensed movement.

19. The method of claim 17, further comprising outputting an operation control signal for the controlling of the operation.

20. The method of claim 19, wherein the operation control signal comprises a signal for operating at least one among operations inherently provided in an apparatus and operations definable by a user.

21. The method of claim 17, further comprising obtaining the sensed movement through a movement sensing device.

22. The method of claim 21, wherein the obtaining of the sensed movement comprises sensing at least one of an acceleration and an angular velocity of the movement.

23. The method of claim 17, wherein the at least one movement model comprises at least one among a number of segments defined by predetermined points in a respective input movement sample to generate the at least one movement model, a correlation between a plurality of movement samples, and a linear relationship matrix including linear variable coefficients determined through learning to reduce a difference between movement samples.

24. The method of claim 23, wherein a method of expressing the correlation between the plurality of movement sample comprises a covariance matrix.

25. The method of claim 23, wherein the correlation comprises a variance of the plurality of movement samples at a border and within the segments corresponding to a predetermined point and an overall variance, of the plurality of movement samples, which has been pre-generated through application of a predetermined weight.

26. The method of claim 23, further comprising generating the at least one movement model using a movement sample.

27. The method of claim 26, wherein the generating of the at least one movement model comprises:
receiving a movement sample;
dividing the received movement sample into segments using the predetermined points as borders;
extracting the correlation between the plurality of movement samples; and
extracting the linear relationship matrix including the linear variable coefficients.

28. The method of claim 26, wherein the generating of the at least one movement model comprises generating the at least one movement model using one among a one-dimensional movement sample, a two-dimensional movement sample, and a three-dimensional movement sample.

29. The method of claim 23, wherein the segments are defined by using, as borders, points where a direction of movement changes on each of axes in space included in the at least one movement sample.

30. The method of claim 17, wherein the comparing of the sensed movement to determine the similarity between the movement models and the sensed movement comprises obtaining a probability value by applying a magnitude of inertial force of the sensed movement to the probability distribution.

31. The method of claim 17, further comprising storing at least one of the movement models and an operation controlling signal, the operation controlling signal corresponding to a respective movement model and used for controlling the operation.

32. The method of claim 17, further comprising selectively controlling a generation of a movement model and reviewing of the sensed movement to output a corresponding operation control signal, corresponding to a respective movement model used by a controller for controlling the operation, based upon an input button signal.

33. A method of controlling an operation according to movement, the method comprising:
receiving a selection command selecting at least one operation among supported operations;
receiving movement after receipt of the selection command;
comparing the received movement with stored movements to determine corresponding similarities; and
storing the received movement as being for the one operation based on a similarity result of the comparison of the received movement with the stored movements.

34. The method of claim 33, further comprising displaying a list of supported operations.

35. The method of claim 34, wherein the receiving of the selection command comprises receiving the selection command selecting at least one of operations comprised in the list and a currently controlled operation.

36. The method of claim 33, wherein the storing of the received movement comprises:
restoring a trajectory of the received movement and converting the trajectory into coordinates;
generating a figure based on the coordinates; and
displaying the figure and a title of an operation corresponding to the selection command.

37. The method of claim 36, wherein the coordinates comprise at least one among one-dimensional coordinates, two-dimensional coordinates, and three-dimensional coordinates.

38. A method of controlling an operation according to movement, the method comprising:
receiving movement;
comparing the received movement with stored movements to determine corresponding similarities;
receiving a selection command selecting at least one operation among supported operations, to correspond with the received movement; and
storing the received movement as corresponding to the one operation based on a similarity result of the comparison of the received movement with the stored movements.

39. The method of claim 38, further comprising displaying a list of supported operations.

40. The method of claim 39, wherein the receiving of the selection command comprises receiving the selection command selecting at least one of operations comprised in the list and a currently controlled operation.

41. The method of claim 38, wherein the storing of the received movement comprises:
restoring a trajectory of the received movement and converting the trajectory into coordinates;
generating a figure based on the coordinates; and
displaying the figure and a title of an operation corresponding to the selection command.

42. The method of claim 41, wherein the coordinates comprise at least one among one-dimensional coordinates, two-dimensional coordinates, and three-dimensional coordinates.

43. At least one medium comprising computer readable code to implement the method of claim 17.

44. At least one medium comprising computer readable code to implement the method of claim 33.

45. At least one medium comprising computer readable code to implement the method of claim 38.
